(19) United States
(12) Patent Application Publication
(10) Pub. No.: US 2025/0226405 A1
(43) Pub. Date: Jul. 10, 2025

(54) POSITIVE ELECTRODE ACTIVE MATERIAL AND METHOD OF PRODUCING POSITIVE ELECTRODE ACTIVE MATERIAL

(71) Applicant: TOYOTA JIDOSHA KABUSHIKI KAISHA, Toyota-shi (JP)

(72) Inventors: Ryosuke OHSAWA, Okazaki-shi (JP); Momoko PROCTER, Seto-shi (JP)

(73) Assignee: TOYOTA JIDOSHA KABUSHIKI KAISHA, Toyota-shi (JP)

(21) Appl. No.: 18/916,744

(22) Filed: Oct. 16, 2024

(30) Foreign Application Priority Data
Jan. 9, 2024 (JP) 2024-001454

(51) Int. Cl. H01M 4/525; H01M 4/02; H01M 4/04; H01M 4/505

(52) U.S. Cl. CPC H01M 4/525; H01M 4/0471; H01M 4/505; H01M 2004/028

(57) ABSTRACT

The present disclosure relates to a positive electrode active material, and a method of producing the positive electrode active material. The positive electrode active material includes LiₓNiₐCo_{b}Mn_{c}O_{y}, in which the crystallite size in the primary particle is not less than 300 nm and not more than 1700 nm. In the composition, 0.1≤x≤1.5, 0.5≤a≤1.0, 0≤b≤0.3, 0≤c≤0.3, a+b+c=1.0, and 1.5≤y≤2.1 are obtained.

### CROSS-REFERENCE TO RELATED APPLICATION

This application claims priority to Japanese Patent Application No. 2024-001454 filed on Jan. 9, 2024, incorporated herein by reference in its entirety.

### BACKGROUND

### 1. Technical Field

The present disclosure relates to a positive electrode active material and a method of producing a positive electrode active material.

### 2. Description of Related Art

Conventionally, methods of controlling crystal grains of particles in positive electrode active materials used in batteries have been attempted. For example, Japanese Unexamined Patent Application Publication No. 2023-36570 (JP 2023-36570 A) discloses a method of producing a large crystal grain aggregate three-way positive electrode material. The method includes: preparing a nickel salt, a cobalt salt, and a manganese salt as a mixed solution; adding a precipitant and a coordinating agent to the mixed solution, and adjusting pH of the mixed solution from 10.5 to 12, and obtaining a precursor A through precipitation; mixing the precursor A after washing and a lithium salt with a ball mill to obtain a precursor B; firing the precursor B in an atmosphere of air or oxygen, the firing being performed by raising a temperature from 400° C. to 800° C. at a speed of 5 to 15° C./min, performing firing at a constant temperature for 1 to 6 h, further raising the temperature from 900° C. to 980° C. at a peed of 1 to 10° C./min, and performing firing at a constant temperature for 8 to 10 h; and cooling the fired precursor B to obtain a large crystal grain aggregate three-way positive electrode material.

### SUMMARY

Batteries are required to have performance in which battery capacities do not decrease even after repeated charging and discharging (that is, maintainability of the battery capacities). However, capacities of some batteries including positive electrodes containing positive electrode active materials may decrease after repeated charging and discharging. Therefore, there is a demand for a positive electrode active material capable of reducing a decrease in battery capacity when the positive electrode active material is used in a battery.

The present disclosure has been made in view of the above circumstances, and an object thereof is to provide a positive electrode active material capable of reducing a decrease in battery capacity when the positive electrode active material is used in a battery, and a method of producing the positive electrode active material.

A mechanism for addressing the above problem includes the following aspects.

<1> A positive electrode active material including a composition that is represented by LiₓNiₐCo_{b}Mn_{c}O_{y}, in which a crystallite size in a primary particle is equal to or greater than 300 nm and equal to or less than 1700 nm:
(in the composition, 0.1≤x≤1.5, 0.5≤a≤1.0, 0≤b≤0.3, 0≤c≤0.3, a+b+c=1.0, and 1.5≤y≤2.1).
   <2> The positive electrode active material according to <1>, in which a plurality of primary particles is aggregated to form secondary particles, and an average number of the primary particles constituting one of the secondary particles is equal to or less than five.
   <3> The positive electrode active material according to <1> or <2>, further including, in the composition, at least one element selected from a group consisting of a group X and a group Y below:
X: Ba, Pr, La, Y, Sr, Ce, Se, Hf, Rh, Zr, Sn, Mg
Y: W, Re, Sb, Sn, Ta, Os, Ir, Mo, Nb, Tc, Ru, Ga, Ag, Pd, Ge, As, Zr, In, Pt, Al, Ti.
   <4> The positive electrode active material according to <3> including: at least one element selected from the group X; and at least one element selected from the group Y (where there are not a case in which the element selected from the group X is only Zr while the element selected from the group Y is only Zr and a case in which the element selected from the group X is only Sn while the element selected from the group Y is only Sn).
   <5> A method of producing a positive electrode active material, the method including: obtaining a mixed product by mixing raw materials each containing Ni, Co and Mn and a raw material containing Li; and
performing stepwise firing in which a low-temperature firing treatment of performing firing at a temperature of equal to or greater than 400° C. and equal to or less than 600° C., a medium-temperature firing treatment of performing firing at a temperature that is equal to or greater than 500° C. and equal to or less than 800° C. and is higher than the temperature in the low-temperature firing treatment, and a high-temperature firing treatment of performing firing at a temperature that is equal to or greater than 600° C. and equal to or less than 1000° C. and is higher than the temperature in the medium-temperature firing treatment are performed in an order of the low-temperature firing treatment, the medium-temperature firing treatment, and the high-temperature firing treatment, in which a positive electrode active material having a composition represented by LiₓNiₐCo_{b}Mn_{c}O_{y} is produced:
(in the composition, 0.1≤x≤1.5, 0.5≤a≤1.0, 0≤b≤0.3, 0≤c≤0.3, a+b+c=1.0, and 1.5≤y≤2.1).

According to the present disclosure, there is provided a positive electrode active material capable of reducing a decrease in battery capacity when the positive electrode active material is used in a battery, and a method of producing the positive electrode active material.

### DETAILED DESCRIPTION OF EMBODIMENTS

### Positive Electrode Active Material

A positive electrode active material according to an embodiment of the present disclosure has a composition represented by LiₓNiₐCo_{b}Mn_{c}O_{y}. The crystallite size in the primary grains of the positive electrode active material is not less than 300 nm and not more than 1700 nm.
(in the composition, 0.1≤x≤1.5, 0.5≤a≤1.0, 0≤b≤0.3, 0≤c≤0.3, a+b+c=1.0, and 1.5≤y≤2.1).

According to the positive electrode active material of the embodiment of the present disclosure, a decrease in capacity of a battery is suppressed. The reason why this effect is achieved is presumed as follows.

One of the performance required for a battery is that a decrease in the battery capacity is suppressed even after repeated charging and discharging (that is, maintenance of the battery capacity). However, capacities of some batteries including positive electrodes containing positive electrode active materials may decrease after repeated charging and discharging. As one of the factors, it is considered that the positive electrode active material reacts with the electrolyte solution and Li is consumed in the coating film, thereby lowering the cell capacity. Therefore, it is required to suppress a decrease in battery capacity due to a reaction with an electrolyte solution in the positive electrode active material.

On the other hand, in the positive electrode active material according to the embodiment of the present disclosure, the crystallite size in the crystal in the primary particle is within the above range. When the crystallite size in the particles of the positive electrode active material is small (that is, when the crystallite size is less than 300 nm), it means that the crystal growing in the positive electrode active material particles is not proceeding. Then, in the positive electrode active material having a small crystallite size, the reaction area increases, and a reaction with the electrolyte solution occurs in the battery. On the other hand, in the positive electrode active material according to the embodiment of the present disclosure, the crystallite size is 300 nm or larger, and crystal growth is sufficiently advanced. Therefore, the reaction area of the positive electrode active material is small, and the reaction with the electrolyte in the battery is suppressed. As a result, Li is suppressed from being consumed due to the formation of the coating film, and a decrease in the capacity of the batteries is suppressed.

Next, the positive electrode active material according to the embodiment of the present disclosure will be described in detail.

### Crystallite Size

The crystallite size of the crystals in the particles (primary particles) of the positive electrode active material is not less than 300 nm and not more than 1700 nm. When the crystallite size is equal to or larger than 300 nm value, the reaction area of the positive electrode active material is small, the reaction with the electrolyte in the battery is suppressed, Li is suppressed from being consumed due to the formation of the coating film, and a decrease in the capacity of the battery is suppressed. On the other hand, when the crystallite size is equal to or smaller than 1700 nm value, a process for increasing the crystallite size, specifically, a firing process can be simplified, and a complicated manufacturing can be suppressed.

The lower limit of the crystallite size in the particles (primary particles) of the positive electrode active material is preferably more than or equal to 500 nm, and more preferably more than or equal to 800 nm, from the viewpoint of suppressing the capacity decrease in the batteries. On the other hand, the upper limit of the crystallite size is preferably less than or equal to 1500 nm, and more preferably less than or equal to 1000 nm, from the viewpoint of simplifying the step for increasing the crystallite size.

The method for controlling the crystallite size of the crystal in the particles (primary particles) of the positive electrode active material is not particularly limited. For example, in order to increase the crystallite size to be equal to or larger than 300 nm value, it is preferable to promote the growth of crystals by performing firing while raising the temperature stepwise from a low temperature to a high temperature in a firing step in producing a positive electrode active material. More preferably, a low-temperature firing treatment for performing firing at a temperature of 400° C. or higher 600° C. or lower, a medium-temperature firing treatment for performing firing at a temperature higher than the temperature in the temperature 500° C. or higher 800° C. or lower and the low-temperature firing treatment, and a high-temperature firing treatment for performing firing at a temperature higher than the temperature in the temperature 600° C. or higher 1000° C. or lower and the medium-temperature firing treatment, it is preferable to pass through a step firing step of performing firing in this order.

### Crystalline Size Calculation Method

Here, a method of calculating the crystallite size in the particles (primary particles) of the positive electrode active material will be described. The crystallite size of the positive electrode active material is measured by a XRD (X-ray diffractometer) measuring device (SmartLab (registered trademark) manufactured by Rigaku Co., Ltd.). From the angle (θ) of the peak present between 17° and 19° and the half width (β), the crystallite size is calculated by the following formula.

$$L = 0.9 \times λ / ( βcosθ ) \qquad Formula$$

(where λ represents the wavelength (Å) of the X-ray.)

The measurement conditions are as follows.
Angle: 10° to 120°
Interval: 0.02°/step
Velocity: 10°/min

### Composition

A positive electrode active material according to an embodiment of the present disclosure includes Li, Ni, and O, and may include at least Co and Mn, and the ratio of these components is expressed by LiₓNiₐCo_{b}Mn_{c}O₂. Further, the positive electrode active material may further contain other additive elements.
(in the composition, 0.1≤x≤1.5, 0.5≤a≤1.0, 0≤b≤0.3, 0≤c≤0.3, a+b+c=1.0, and 1.5≤y≤2.1).

In the positive electrode active material, the ratio x of Li is 0.1 or more and 1.5 or less, preferably 0.3 or more and 1.4 or less, and more preferably 0.5 or more and 1.2 or less, from the viewpoint of suppressing a decrease in capacity in the battery. The ratio a of Ni is 0.5 or more and 1.0 or less, preferably 0.6 or more and 0.9 or less, and more preferably 0.7 or more and 0.8 or less, from the viewpoint of suppressing a decrease in capacity in a battery or the like. The ratio b of Co is 0 or more and 0.3 or less, preferably 0 or more and 0.2 or less, and more preferably 0.1 or more and 0.2 or less, from the viewpoint of suppressing a decrease in capacity in a battery or the like. The ratio c of Mn is 0 or more and 0.3 or less, preferably 0 or more and 0.2 or less, and more preferably 0.1 or more and 0.2 or less, from the viewpoint of suppressing a decrease in capacity in a battery or the like. The sum (a+b+c) of the ratios of Ni, Co and Mn is 1.0.

The positive electrode active material may further contain other additive elements. In particular, from the viewpoint of suppressing a decrease in capacity in a battery or the like, the positive electrode active material preferably further contains at least one element selected from the group consisting of the following group X and the following group Y.
X: Ba, Pr, La, Y, Sr, Ce, Se, Hf, Rh, Zr, Sn, Mg
Y: W, Re, Sb, Sn, Ta, Os, Ir, Mo, Nb, Tc, Ru, Ga, Ag, Pd, Ge, As, Zr, In, Pt, Al, Ti.

In addition, from the viewpoint of suppressing a decrease in capacity in the battery, it is preferable that the positive electrode active material contains at least one element selected from the group X and at least one element selected from the group Y. However, the element selected from the group X is only Zr and the element selected from the group Y is not only Zr, and the element selected from the group X is not only Sn and the element selected from the group Y is not only Sn.

A combination of an element selected from the group X and an element selected from the group Y, which is preferably included in the positive electrode active material, is shown below. From the viewpoint of suppressing a decrease in capacity in a battery or the like, the positive electrode active material preferably contains one or more of the following combinations of elements. In addition, the combination shown below represents an element in which the element described before “—” is selected from the group X, and an element in which the element described after “—” is selected from the group Y.
Preferred combinations of elements of group X and elements of group Y Ba—W, Pr—W, La—W, Y—W, Sr—W, Ce—W, Pr—Re, Ba—Re, Sr—Sb, Se—W, Y—Re, Hf—W, Sr—Re, Rh—W, Zr—W, Sr—Sn, Y—Ta, Pr—Ta, Y—Sb, Sr—Os, Sr—Ta, Ce—Re, La—Re, Ba—Ta, Sr—Ir, Sn—W, Sr—Mo, Sr—Nb, Ba—Ti, Ba—Zr, Ba—Al

The content ratio (mass %) of the element selected from the group X in the positive electrode active material is preferably 0.0005 or more and 0.05 or less and preferably 0.001 or more and 0.040 or less from the viewpoint of suppressing a decrease in capacity in the battery. 0.003 It is more preferably not less than 0.030. The content ratio (mass %) of the element selected from the group Y in the positive electrode active material is preferably 0.0005 or more and 0.05 or less and preferably 0.001 or more and 0.040 or less from the viewpoint of suppressing a decrease in capacity in the battery. 0.003 It is more preferably not less than 0.030.

### Secondary Particle

In the positive electrode active material according to the embodiment of the present disclosure, it is preferable that a plurality of primary particles aggregate to form secondary particles. From the viewpoint of suppressing a decrease in capacity in the battery, it is preferable that the average number of primary particles constituting one secondary particle is 5 or less.

It is to be noted that the positive electrode active material forms secondary grains, which can be confirmed by observing the cross-section of the positive electrode active material layers with a scanning electron-microscope (SEM). In addition, the average number of primary particles constituting the secondary particles in the positive electrode active material is calculated by measuring the number of primary particles constituting each of the secondary particles with an arbitrary 50 secondary particles as a measurement target in observation with the microscope, and obtaining an arithmetic average value thereof.

A method for producing a positive electrode active material, the method comprising:

Next, a method for producing a positive electrode active material according to an embodiment of the present disclosure will be described. Note that the positive electrode active material according to the embodiment of the present disclosure described above can be manufactured by the method for manufacturing a positive electrode active material according to the embodiment of the present disclosure described below.

A method for producing a positive electrode active material according to an embodiment of the present disclosure includes: a step of mixing a raw material containing Ni, Co and Mn and a raw material containing Li to obtain a mixture; and a step of performing a low-temperature firing treatment for firing the mixture at a temperature of 400° C. or higher and 600° C. or lower, a medium-temperature firing treatment for firing at a temperature of 500° C. or higher and 800° C. or lower and at a temperature higher than the temperature in the low-temperature firing treatment, and a step of performing a high-temperature firing treatment for firing at a temperature of 600° C. or higher and 1000° C. or lower and higher than the temperature in the medium-temperature firing treatment, in this order. Then, a positive electrode active material having a composition represented by LiₓNiₐCo_{b}Mn_{c}O_{y} is produced (in the composition, 0.1≤x≤1.5, 0.5≤a≤1.0, 0≤b≤0.3, 0≤c≤0.3, a+b+c=1.0, and 1.5≤y≤2.1).

In the method for producing a positive electrode active material according to the embodiment of the present disclosure, as described above, the method includes a step-firing step of performing firing while raising the temperature stepwise from a low temperature to a high temperature. Therefore, it is possible to promote the growth of crystals in the grains of the positive electrode active material, and it is possible to increase the crystallite size to be equal to or larger than 300 nm. As a result, a positive electrode active material having a small reaction area with the positive electrode active material and capable of suppressing reaction with the electrolyte in the battery can be obtained. When the positive electrode active material is used for a battery, Li is suppressed from being consumed by forming a coating film, and a decrease in the capacity of the battery is suppressed.

It is preferable that the method for producing a positive electrode active material according to the embodiment of the present disclosure includes the following steps (1) to (5).
(1) A step of preparing a solution in which a raw material containing Ni, Co and Mn is dissolved (raw material dissolving step)
(2) A step of adding the solution to an alkaline solution and precipitating a hydroxide (crystallization step)
(3) Step of collecting a precipitate from the alkaline solution
(4) A step of mixing the precipitate and a raw material containing Li to obtain a mixture (mixing step)
(5) Baking the mixture (baking step)

When an additive element is contained in the positive electrode active material, it is preferable to further add a raw material containing the additive element in the (4) mixing step. Examples of the additive element include an element selected from the group X and an element selected from the group Y.

Hereinafter, each step will be described in detail.

(1) Step of Preparing Solutions in which Raw Materials Containing Ni, Co, and Mn, Respectively, are Dissolved

Solutions obtained by dissolving a raw material containing Ni, a raw material containing Co, and a raw material containing Mn are prepared. For example, a solution can be prepared by dissolving a raw material containing Ni, a raw material containing Co, and a raw material containing Mn in a solvent such as water. The concentration of the solution is preferably in the range of, for example, 10 to 40% by mass. The ratio of Ni/Co/Mn, relative to Ni:1.0, it is preferable to the ratio of 1.0/0.8 to 1.2/0.8 to 1.2 (atm %).

Examples of the raw material containing Ni include a sulfate such as NiSO₄; examples of the raw material containing Co include a sulfate such as CoSO₄; and examples of the raw material containing Mn include a sulfate such as MnSO₄.

### (2) Step of Adding a Solution to the Alkaline Solution and Precipitating the Hydroxide

The solution is then added to the alkaline solution to precipitate the hydroxide. As a result, the particles in which the hydroxide containing Ni, Co and Mn is formed are crystallized, and the particles are obtained as a precipitate. In this step, the transition-metal hydroxide is precipitated, for example, by dropping the solution and NH₃ while controlling the alkaline solution in which the hydroxide is precipitated to a certain pH (e.g., pH10 to 12).

(3) Step of Collecting the Precipitate from the Alkaline Solution

The precipitate is then collected from the alkaline solution. Examples of the method for collecting particles of the precipitate include filtration and washing with water. First, the precipitate (particles) is taken out by filtration, washed with water, and then the washed liquid is filtered to take out the precipitate (particles). The precipitate (particles) after washing with water may be further dried.

(4) Step of Mixing the Precipitate with a Raw Material Containing Li to Obtain a Mixture

The collected precipitate (particulates) and the raw material containing Li are then mixed to obtain a blend. When the positive electrode active material contains an additive element, it is preferable to further add a raw material containing the additive element. Examples of the additive element include an element selected from the group X and an element selected from the group Y. Examples of the mixing method include a method of mixing particles of the collected precipitate, a raw material containing Li, and a raw material containing an additive element (for example, a raw material containing an element selected from the aforementioned group X and an element selected from the group Y) in a mortar.

Examples of the raw material containing Li include Li₂CO₃, and LiOH. Examples of the raw material containing an element selected from the group X described above (i.e., at least one element selected from the group consisting of Ba, Pr, La, Y, and Sr, Ce, Se, Hf, Rh, Zr, Sn, Mg) and an element selected from the group Y described above (i.e., at least one element selected from the group consisting of W and Re, Sb, Sn, Ta, Os, Ir, Mo, Nb, Tc, Ru, Ga, Ag, Pd, Ge, As, Zr, In, Pt, Al, Ti) include oxides of each element (e.g., BaO, Pr₂O₃, La₂O₃, SrO, W₂O₃, MoO₃, and NbO).

### (5) Step of Calcining the Mixture

Then, the mixture of the collected precipitate (grains) and the raw material containing Li is calcined. For example, the mixture can be calcined by a calcination furnace (such as a muffle furnace).

In the method for producing a positive electrode active material according to the embodiment of the present disclosure, each of the firing processes shown in the following (a) to (c) is performed in this order.
(a) A low-temperature firing treatment for firing at a temperature of 400° C. or higher and 600° C. or lower
(b) A medium-temperature firing treatment which fires at a temperature higher than the temperature in the aforementioned low-temperature firing treatment above 500° C. and below 800° C.
(c) A high-temperature firing treatment which fires at a temperature higher than the temperature in the above-mentioned medium-temperature firing treatment at 600° C. or more and 1000° C. or less.

Through the above-described step firing step, the crystallites can be grown in the grains of the positive electrode active material, and the crystallite size can be increased to be equal to or larger than 300 nm.

(a) The temperature in the low-temperature firing treatment is 400° C. or more and 600° C. or less, and from the viewpoint of suppressing a decrease in capacity in the battery or the like, it is preferably 420° C. or more and 580° C. or less, and more preferably 450° C. or more and 550° C. or less. (a) The heating time at the temperature in the low-temperature firing treatment is preferably 1 hour or more and 5 hours or less, and more preferably 2 hours or more and 4 hours or less, from the viewpoint of suppressing a decrease in capacity in the battery.

(b) The temperature in the medium-temperature firing treatment is 500° C. or more and 800° C. or less, and from the viewpoint of suppressing a decrease in capacity in the battery or the like, it is preferably 550° C. or more and 750° C. or less, and more preferably 600° C. or more and 700° C. or less. (b) The heating time at the temperature in the medium-temperature firing treatment is preferably 1 hour or more and 5 hours or less, and more preferably 2 hours or more and 4 hours or less, from the viewpoint of suppressing a decrease in capacity in the battery.

(c) The temperature in the high-temperature firing treatment is 600° C. or more and 1000° C. or less, and is preferably 550° C. or more and 750° C. or less, and more preferably 600° C. or more and 700° C. or less from the viewpoint of suppressing a decrease in capacity in the battery. (c) The heating time at the temperature in the high-temperature firing treatment is preferably 1 hour or more and 5 hours or less, and more preferably 2 hours or more and 4 hours or less, from the viewpoint of suppressing a decrease in capacity in the battery or the like.

The calcination is preferably carried out under an oxygen atmosphere. In order to set the positive electrode active material to a predetermined particle diameter, the mixture after firing may be subjected to crushing. Examples of the method of crushing include a method of pulverizing by a pulverizer (for example, a jet mill).

Through these steps, the positive electrode active material according to the embodiment of the present disclosure can be obtained.

### Battery

The positive electrode active material according to the embodiment of the present disclosure can be used in a battery, and is particularly preferably used in a lithium ion battery. The battery includes, for example, a negative electrode, a positive electrode, a separator, and an electrolyte.

The battery according to the embodiment of the present disclosure may be a solid battery having a solid electrolyte or a liquid battery having a liquid electrolyte, but is preferably a liquid battery. In addition, a bipolar battery including a positive electrode active material layer and a negative electrode active material layer on both surfaces of a current collector having functions of a positive electrode current collector and a negative electrode current collector may be used.

The positive electrode includes, for example, a positive electrode current collector and a positive electrode active material layer fixed on the positive electrode current collector. The negative electrode includes, for example, a negative electrode current collector and a negative electrode active material layer fixed on the negative electrode current collector. The separator is an electrically insulating porous film. The separator electrically isolates the positive electrode and the negative electrode. The battery according to the embodiment of the present disclosure may further be a liquid-based battery having an electrolytic solution. In particular, a non-aqueous electrolyte solution is preferable. Applications of batteries include, for example, power supplies such as hybrid electric vehicle (HEV), plug-in hybrid electric vehicle (PHEV), battery electric vehicle (BEV).

Hereinafter, the present disclosure will be described based on Examples, but the present disclosure is not limited to these Examples in any way.

### Example 1

### Synthesis of Positive Electrode Active Material

### Raw Material Dissolving Solution

NiSO₄, CoSO₄, and MnSO₄ were dissolved in ion-exchanged water to obtain a raw material solution. The ratio of Ni/Co/Mn was 1/1/1 (atm %) and the aqueous solution was 30 wt %.

### Crystallization

A fixed volume of NH₃ aqueous solution was placed in the reactor and nitrogen-substituted with stirrer. NaOH was added to the reactor to make pH alkaline. Then, the raw material solution and NH₃ were added dropwise while controlling the inside of the reactor from a constant pH (pH10 to 12), and the transition-metal hydroxide was precipitated.

Washing with Water, Filtration, Drying

The precipitated transition metal hydroxide was removed by filtration, and ion-exchanged water was added thereto, and the mixture was stirred and dispersed by a spoon, and washed with water. The washed solution was then filtered to remove the transition metal hydroxide. The filtered transition metal hydroxide was then dried at 120° C. for 16 hours and the water evaporated.

### Mixing of Raw Materials of Li and Additive Elements

The dried transition-metal hydroxide, Li₂CO₃ and LiOH as Li raw material, MgO as the raw material of the additive element 1, and Al₂O₃ as the raw material of the additive element 2 were mixed in a mortar.

### Calcination and Crushing

Mixtures of transition-metal hydroxides with Li raw materials and with raw materials of additive elements were calcined in a calcination furnace (muffle furnace). Incidentally, this firing, low-temperature firing treatment at 500° C., medium-temperature firing treatment at 700° C., and high-temperature firing treatment at 900° C., each performed for 3 hours in this order in an oxygen atmosphere, a step firing process.

Then, the mixture after calcination was pulverized by a pulverizer (jet mill) to crush to a predetermined particle size. Thus, the positive electrode active material of Example 1 was obtained.

The positive electrode active material of Example 1 contained Li, Ni, Co, Mn, O, Mg, and Al, and the ratio (mass ratio) was the ratio shown in Table 1.

The obtained positive electrode active material had a plurality of primary particles aggregated to form secondary particles, and the average number of primary particles constituting one secondary particle was 5 or less.

### Examples 2 to 6

The positive electrode active material of the respective examples was obtained in the same manner as in Example 1, except that the raw material of the additive element 1 in Example 1 was changed to La₂O₃ (Example 2), SrO (Example 3), and Pr₂O₃ (Example 4) from MgO, and the raw material of the additive element 2 was changed to W₂O₃ (Examples 2 and 4) and NbO (Example 3) from Al₂O₃.

Table 1 shows the elements contained in the positive electrode active material of each example and the ratio (mass ratio) thereof. The obtained positive electrode active material had a plurality of primary particles aggregated to form secondary particles, and the average number of primary particles constituting one secondary particle was 5 or less.

### Comparative Example 1

A positive electrode active material of Comparative Example 1 was obtained in the same manner as in Example 1, except that the raw material of the additive element 1 and the raw material of the additive element 2 in Example 1 were not added, and the firing condition was changed to the condition of firing under an oxygen atmosphere at a temperature of 900° C. for 10 hours.

Table 1 shows the elements contained in the positive electrode active material of Comparative Example 1 and the ratio (mass ratio) thereof. The obtained positive electrode active material had a plurality of primary particles aggregated to form secondary particles, and the average number of primary particles constituting one secondary particle was 5 or less.

### Comparative Example 2

A positive electrode active material of Comparative Example 2 was obtained in the same manner as in Example 1, except that the firing conditions in Example 1 were changed to conditions for firing in an oxygen atmosphere at a temperature of 900° C. for 10 hours.

Table 1 shows the elements contained in the positive electrode active material of Comparative Example 2 and the ratio (mass ratio) thereof. The obtained positive electrode active material had a plurality of primary particles aggregated to form secondary particles, and the average number of primary particles constituting one secondary particle was 5 or less.

### Cell Fabrication

Cells were prepared using the positive electrode active materials obtained in Examples and Comparative Examples.

### Cell Configuration

### Wound Cylinder

Positive electrode composition:positive electrode active material/acetylene black (conductive material)/polyvinylidene fluoride=88/10/2 (mass %)

### Natural Graphite/Styrene Butadiene Rubber (SBR)/Carboxymethylcellulose (CMC)

Electrolyte composition:electrolyte=LiPF₆ (1M), solvent=ethylene carbonate (EC)/dimethyl carbonate (DMC)/ethyl methyl carbonate (EMC)=3/4/3 (vol %)

### Fabrication of Electrodes

A film applicator with a film thickness adjusting function (All Good Co., Ltd.) was used to coat a positive electrode and a negative electrode on a current collector, and dried in a dryer at 80° C. for 5 minutes to prepare a cell.

### Crystalline Size Calculation Method

The positive electrode active materials obtained in Examples and Comparative Examples were measured for crystallite size using a XRD (X-ray diffractometer) (manufactured by Rigaku Co., Ltd., SmartLab (registered trademark)). The crystallite size was calculated from the angle (θ) of the peak present between 17° and 19° and the half width (β) by the following formula.

$$L = 0.9 \times λ / ( βcosθ ) \qquad Formula$$

(where X represents the wavelength (Å) of the X-ray.)

The measurement conditions were as follows.
Angle: 10° to 120°
Interval: 0.02°/step
Velocity: 10°/mi
   Measurement of Capacity Retention after Cycling

For the cells obtained in the Examples and Comparative Examples, the battery capacity was measured before and after the cycle under the following test conditions. Table 1 shows the results of the ratio of the battery capacity after the cycle (capacity retention ratio (%)) when the battery capacity before the cycle is “100%”. It can be said that as the capacity retention ratio is close to 100%, the battery characteristics are better.
Test conditions: 300 cycles between SOC 0% and 100% at 2C rates at 60° C., and charge/discharge.

Incidentally, the “synthesis method 2” shown in Table 1, the low-temperature firing treatment for firing at a temperature of 400° C. or higher 600° C. or lower, the temperature 500° C. or higher 800° C. or lower and lower than the temperature in the low-temperature firing treatment medium-temperature firing treatment, and the temperature 600° C. or higher 1000° C. or lower than the temperature in the medium-temperature firing treatment high-temperature firing treatment, a synthesis method having a step firing process performed in this order. On the other hand, the “synthesis method 1” means a synthesis method that does not have the above-described step firing step.

TABLE 1

| | | | | | | | | | | | | Capacity |
|---|---|---|---|---|---|---|---|---|---|---|---|---|
| | | | | | | | | | | | | retention |
| | Li | Ni | Co | Mn | O | Additive | | Additive | | | Crystallite | after |
| | Ratio | Ratio | Ratio | Ratio | Ratio | element 1 | | element 2 | | Synthetic | size | cycle |
| | x | a | b | c | y | Type | Ratio | Type | Ratio | method | Å | % |
| Comparative | 1.1 | 0.8 | 0.1 | 0.1 | 2.0 | None | | None | | 1 | 297 | 80 |
| Example 1 | | | | | | | | | | | | |
| Comparative | 1.1 | 0.8 | 0.1 | 0.1 | 2.0 | Mg | 0.01 | Al | 0.01 | 1 | 299 | 79 |
| Example 2 | | | | | | | | | | | | |
| Example 1 | 1.1 | 0.8 | 0.1 | 0.1 | 2.0 | Mg | 0.01 | Al | 0.01 | 2 | 1652 | 95 |
| Example 2 | 1.1 | 0.8 | 0.1 | 0.1 | 2.0 | La | 0.01 | W | 0.01 | 2 | 309 | 95 |
| Example 3 | 1.1 | 0.8 | 0.1 | 0.1 | 2.0 | Sr | 0.01 | Nb | 0.01 | 2 | 987 | 96 |
| Example 4 | 1.1 | 0.8 | 0.1 | 0.1 | 2.0 | Pr | 0.01 | W | 0.01 | 2 | 315 | 97 |

As shown in Table 1, it can be seen that the positive electrode active material of each example in which the crystallite size falls within a specific range is superior in maintaining the battery capacity as compared with the positive electrode active material of each comparative example in which the crystallite size falls below the specific range.

What is claimed is:

1. A positive electrode active material comprising a composition that is represented by LiₓNiₐCo_{b}Mn_{c}O_{y}, wherein a crystallite size in a primary particle is equal to or greater than 300 nm and equal to or less than 1700 nm:
(in the composition, 0.1≤x≤1.5, 0.5≤a≤1.0, 0≤b≤0.3, 0≤c≤0.3, a+b+c=1.0, and 1.5≤y≤2.1).

2. The positive electrode active material according to claim 1, wherein a plurality of primary particles is aggregated to form secondary particles, and an average number of the primary particles constituting one of the secondary particles is equal to or less than five.

3. The positive electrode active material according to claim 1, further comprising, in the composition, at least one element selected from a group consisting of a group X and a group Y below:
X: Ba, Pr, La, Y, Sr, Ce, Se, Hf, Rh, Zr, Sn, Mg
Y: W, Re, Sb, Sn, Ta, Os, Ir, Mo, Nb, Tc, Ru, Ga, Ag, Pd, Ge, As, Zr, In, Pt, Al, Ti.

4. The positive electrode active material according to claim 3 comprising:
at least one element selected from the group X; and
at least one element selected from the group Y
(where there are not a case in which the element selected from the group X is only Zr while the element selected from the group Y is only Zr and a case in which the element selected from the group X is only Sn while the element selected from the group Y is only Sn).

5. A method of producing a positive electrode active material, the method comprising:
obtaining a mixed product by mixing raw materials each containing Ni, Co and Mn and a raw material containing Li; and
performing stepwise firing in which a low-temperature firing treatment of performing firing at a temperature of equal to or greater than 400° C. and equal to or less than 600° C., a medium-temperature firing treatment of performing firing at a temperature that is equal to or greater than 500° C. and equal to or less than 800° C. and is higher than the temperature in the low-temperature firing treatment, and a high-temperature firing treatment of performing firing at a temperature that is equal to or greater than 600° C. and equal to or less than 1000° C. and is higher than the temperature in the medium-temperature firing treatment are performed in an order of the low-temperature firing treatment, the medium-temperature firing treatment, and the high-temperature firing treatment, wherein a positive electrode active material having a composition represented by LiₓNiₐCo_{b}Mn_{c}O_{y} is produced:
(in the composition, 0.1≤x≤1.5, 0.5≤a≤1.0, 0≤b≤0.3, 0≤c≤0.3, a+b+c=1.0, and 1.5≤y≤2.1).
